(19) United States
(12) Patent Application Publication
(10) Pub. No.: US 2013/0155432 A1
(43) Pub. Date: Jun. 20, 2013

(54) SCANNING AND PRINTING DEVICE AND METHOD OF SCANNING AND PRINTING

(71) Applicants: Chao-Ming Chen, New Taipei City (TW); Wei-Sheng Lee, New Taipei City (TW)

(72) Inventors: Chao-Ming Chen, New Taipei City (TW); Wei-Sheng Lee, New Taipei City (TW)

(73) Assignees: CAL-COMP ELECTRONICS & COMMUNICATIONS COMPANY LIMITED, New Taipei City (TW); KINPO ELECTRONICS, INC., New Taipei City (TW)

(21) Appl. No.: 13/429,455

(22) Filed: Mar. 26, 2012

(30) Foreign Application Priority Data
Dec. 19, 2011 (TW) 100147161

(51) Int. Cl. G06K 15/16; G06F 3/12

(52) U.S. Cl. 358/1.12; 358/1.13

(57) ABSTRACT

A scanning and printing device for scanning a first paper and printing a second paper is provided. The scanning and printing device includes a carriage, a sensing module, and a printing module. The carriage slides back and forth along an axial direction. The carriage has a top surface and a base surface opposite to each other. The top surface faces the first paper, and the base surface faces the second paper. The sensing module is disposed on the top surface of the carriage to capture an image on the first paper. The printing module is disposed on the base surface of the carriage to print the image to the second paper.

### CROSS-REFERENCE TO RELATED APPLICATION

This application claims the priority benefit of Taiwan application serial no. 100147161, filed on Dec. 19, 2011. The entirety of the above-mentioned patent application is hereby incorporated by reference herein and made a part of this specification.

### BACKGROUND OF THE INVENTION

1. Field of the Invention

The invention relates to a printing and scanning device, and in particular, to a device using a carriage to perform printing and scanning.

2. Description of the Related Art

A light sensor for sensing images, for example, a charge coupling device (CCD) or a contact image sensor (CIS), is generally used in image converting apparatuses, such as copy machines, fax machines, and scanning machines, which convert visual images into compatible electronic formats for printing, storing, transmitting, or the like. In terms of color imaging, common structures of these light sensors are composed of arranged CCD element arrays of three colors, i.e., red, green and blue. Usually, all CCD element arrays are exposed to light for a period of time, and then the sensed charges are transmitted to a CCD analog shift register for later processing.

In office machines, generally, a scanning module scans step by step to obtain analog image signals, and the signals are processed to generate digital signals, which are transmitted to a printing module, so that the image of the regenerated document can be printed out. Thus, scanning modules and printing modules that are specifically for scanning and printing are commonly applied in the office machines nowadays. However, the existing office machines cannot fulfil the market demand for thin, compact, and lightweight electronic devices. Accordingly, persons skilled in the art should consider how to improve the scanning and printing devices stated above from the aspects of costs, space and the appearance thereof.

### SUMMARY OF THE INVENTION

The invention relates to a scanning and printing device and a method of scanning and printing with better spatial allocation and improved scanning and printing efficiencies.

An exemplary embodiment of the invention provides a scanning and printing device for scanning a first paper and printing on a second paper. The scanning and printing device includes a carriage, a sensing module, and a printing module. The carriage moves back and forth along an axial direction. The carriage has a top surface facing a first paper and a base surface facing a second paper, and the top surface and the base surface are opposite to each other. The sensing module is disposed on the top surface of the carriage in order to scan an image on the first paper. The printing module is disposed on the base surface of the carriage in order to print the image to the second paper.

An embodiment of the invention provides a method of scanning and printing, which is applicable to a scanning and printing device for scanning a first paper and printing on a second paper. The scanning and printing device includes a carriage, a sensing module, and a printing module. The carriage includes a top surface and a base surface opposite to each other. The sensing module is disposed on the top surface, and the printing module is disposed on the base surface. The method of scanning and printing includes driving the carriage to pass between the first paper and the second paper, scanning an image of the first paper with use of the sensing module, and printing the image onto the second paper using the printing module.

In an embodiment of the invention, the first paper and the second paper are dislocated against each other along a paper-feeding direction, so that after the sensing module scans at least part of the image of the first paper, the printing module prints the image to the second paper, wherein the paper-feeding direction is perpendicular to the axial direction.

In an embodiment of the invention, the sensing module and the printing module are dislocated against each other along a paper-feeding direction, so that after the sensing module scans at least part of the image of the first paper, the printing module prints the image to the second paper, wherein the paper-feeding direction is perpendicular to the axial direction.

In an embodiment of the invention, the speed of the first paper is greater than that of the second paper.

According to an embodiment of the invention, the sensing module includes a plurality of sensing units arranged on the top surface. The printing module includes a plurality of printing units arranged on the base surface. Arrangement of the sensing units is consistent with that of the printing units.

In an embodiment of the invention, each of the sensing units is a contact image sensor (CIS), and each of the printing units is an ink nozzle.

In an embodiment of the invention, the orthographic projections of each of the sensing units on the base surface are respectively overlapped on the printing units.

In an embodiment of the invention, the sensing units and the printing units are respectively arranged in a non-linear manner.

In an embodiment of the invention, the scanning and printing device further includes a body and an axis shaft. The body has a first paper-feeding region and a second paper-feeding region. The first paper is suitable to be conveyed in the first paper-feeding region, while the second paper is suitable to be conveyed in the second paper-feeding region. The axis shaft is disposed extendedly along the axial direction inside the body and located between the first paper-feeding region and the second paper-feeding region. The carriage is slidably coupled to the axis shaft. The printing module is an ink cartridge disposed on the carriage.

In an embodiment of the invention, the scanning and printing device further includes a control unit electrically connected between the sensing module and the printing module. The control unit has an image buffer region. The image scanned by the sensing unit is stored in the image buffer region and then transmitted to the printing module.

In an embodiment of the invention, the method further includes driving the sensing module and the printing module simultaneously to scan the image of the first paper and print the image to the second paper.

In an embodiment of the invention, the method further includes dislocating the first paper and the second paper against each other along a paper-feeding direction, so as to allow the sensing module to scan at least part of the image of the first paper and allow the printing module to print the image to the second paper.

In an embodiment of the invention, a speed of the first paper is greater than that of the second paper.

Based on the above, in the above embodiments of the invention, a user can selectively scan the first paper located on the top surface of the carriage, print images to the second paper located beneath the base surface of the carriage, or simultaneously perform the both because the sensing module and the printing module are disposed on the top surface and the base surface of the carriage at the same time. This enables the printing and scanning device to effectively integrate the printing and scanning modules by a carriage so as to decrease the space taken inside the body. Further, due to the synchronization of scanning and printing, working efficiency can be improved.

In order to make the aforementioned features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a scanning and printing device according to an embodiment of the invention.

FIG. 2 is a side view illustrating some components of the scanning and printing device of FIG. 1.

FIG. 3 is a block diagram illustrating some components of the scanning and printing device of FIG. 1.

FIG. 4A and FIG. 4B respectively illustrate the sensing module and the printing module on the carriage shown in FIG. 1.

FIG. 5 is a flow chart illustrating the scanning and printing device of FIG. 1 in the first state.

FIG. 6 is a schematic view illustrating the scanning and printing device of FIG. 1 in the second state.

FIG. 7 is a side view illustrating some components of a scanning and printing device according to another embodiment of the invention.

### DETAILED DESCRIPTION OF DISCLOSED EMBODIMENTS

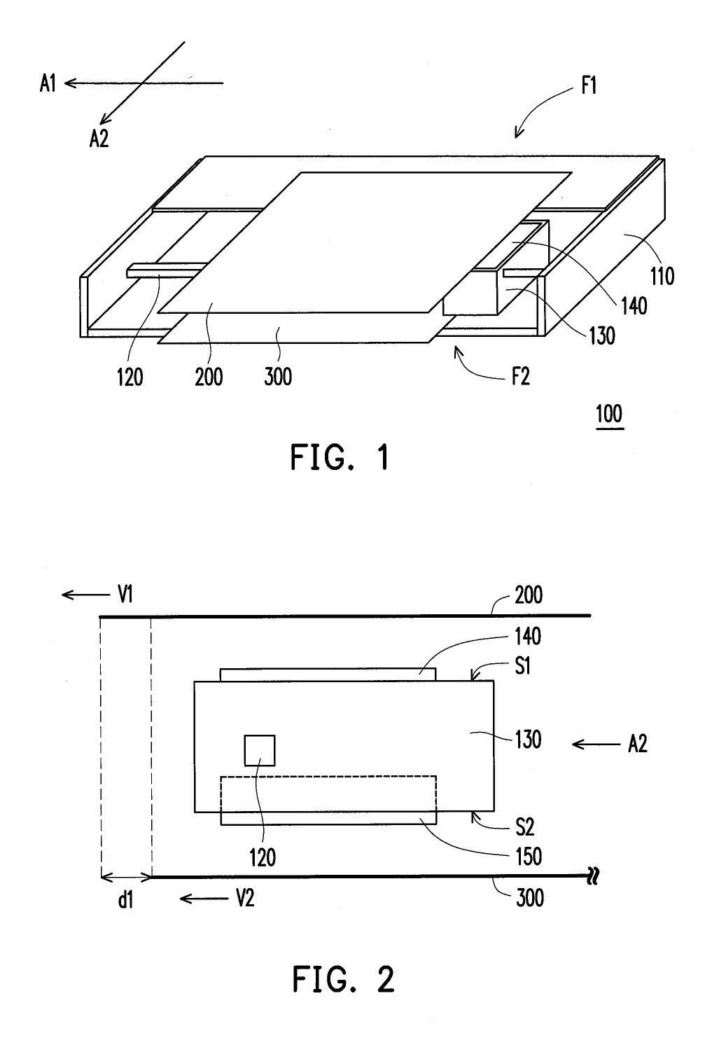

FIG. 1 is a schematic view of a scanning and printing device according to an embodiment of the invention. FIG. 2 is a side view illustrating some components of the scanning and printing device of FIG. 1. Please refer to FIG. 1 and FIG. 2. In this embodiment, the scanning and printing device 100 is, for example, an office machine, a printing machine, or any other electronic devices that have both printing and scanning functions, which should not be construed as a limitation to the invention. The scanning and printing device 100 includes a body 110, an axis shaft 120, a carriage 130, a sensing module 140, and a printing module 150. The body 110 has a first paper-feeding region F1 and a second paper-feeding region F2. A first paper 200 is suitable to be conveyed in the first paper-feeding region F1 along a paper-feeding direction A2, while a second paper 300 is suitable to be conveyed in a second paper-feeding region F2 also along the paper-feeding direction A2. The axis shaft 120 is extendedly disposed inside the body 110 along a driving axial direction A1 and located between the first paper-feeding region F1 and the second paper-feeding region F2. The carriage 130 is coupled to the axis shaft 120 and slides back and forth along the driving axial direction A1.

Furthermore, the carriage 130 has a top surface S1 and a base surface S2 opposite to each other, wherein the sensing module 140 is disposed on the top surface S1, while the printing module 150 is disposed on the base surface S2. Accordingly, the sensing module 140 can be used for scanning an image of the first paper 200, and the printing module 150 can be used for printing the image to the second paper 300. Due to integration of the sensing module 140 and the printing module 150 onto the carriage 130, spatial allocation of relevant components can be effectively achieved, so as to reduce the volume of the body 110 and improve scanning and printing efficiencies.

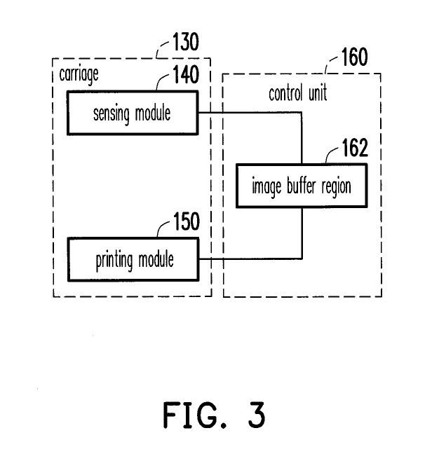

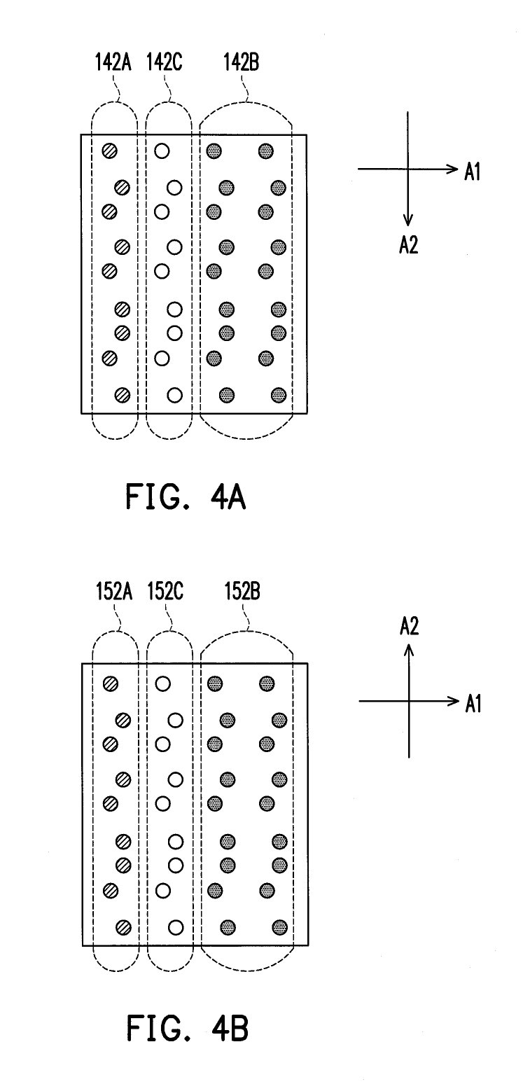

FIG. 3 is a block diagram illustrating some components of the scanning and printing device of FIG. 1. FIG. 4A and FIG. 4B respectively illustrate the sensing module and the printing module on the carriage shown in FIG. 1. Please refer to FIG. 3, FIG. 4A and FIG. 4B. Specifically, in this embodiment, the sensing module 140 includes a plurality of sensing units 142A, 142B and 142C arranged on the top surface S1 of the carriage 130, which are, for example, a plurality of contact image sensors (CIS). In addition, the printing module 150 includes a plurality of printing units 152A, 152B and 152C arranged on the base surface S2 of the carriage 130, which are, for example, a plurality of ink nozzles.

The scanning and printing device 100 further includes a control unit 160 electrically connected between the sensing module 140 and the printing module 150. The control unit 160 has an image buffer region 162, and the image scanned by the sensing module 140, after being digitized, is stored in the image buffer region 162 temporarily. The image is then transmitted from the image buffer region 162 to the printing module 150 for printing.

Note that the arrangement of the sensing units 142A, 142B and 142C is consistent with the arrangement of the printing units 152A, 152B and 152C. Further, the sensing units 142A, 142B and 142C are sorted into a plurality of red sensing units 142A, green sensing units 142B, and blue sensing units 142C. Similarly, the printing module 150 is also composed of a plurality of red printing units 152A, green printing units 152B, and blue printing units 152C. Through the same layout of the sensing units on the top surface S1 and the printing units on the base surface S2 of the carriage 130, the image scanned by the sensing module 140 may be consistent with the image printed by the printing module 150, that is, the characteristics of the scanned image and the printed image are identical in size, resolution, and color distribution. As such, the effect of “seeing is printing” can be created.

That is, in the scanning and printing device 100 described in this embodiment, the image scanned by the sensing module 140 merely needs to be digitized by an analog front end (AFE) controller and can then be stored in the image buffer region 162 and later transmitted to the printing module 150 for printing. Nevertheless, given that the arrangement and layout of the sensing module and the printing module are not identical, the image scanned and digitized based on the related art still has to go through complex processing procedures to be ready for printing. By comparison, the scanning and printing device 100 of the invention can effectively reduce the image processing procedures that are conventionally required, and thus has better scanning and printing efficiencies.

In this embodiment, the sensing module 140 and the printing module 150 are respectively arranged in a non-linear manner; nevertheless, the way that the modules are arranged is not limited in the invention. That is, the designer can select and arrange corresponding sensing units 142A, 142B and 142C and printing units 152A, 152B according to actual requirements for printing, e.g., image size, image resolution, etc.

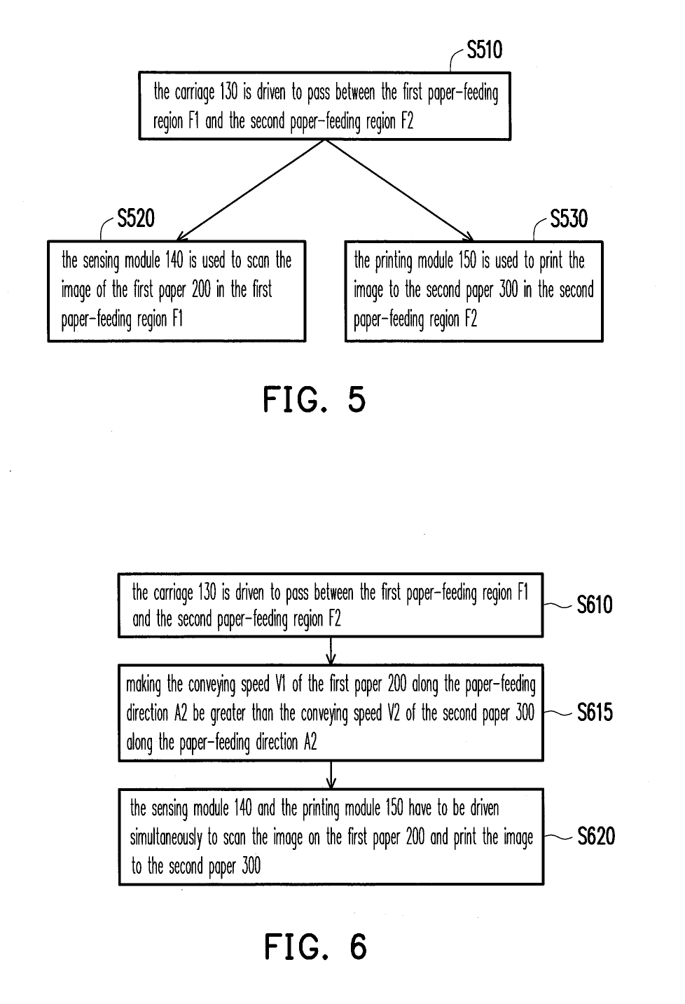

FIG. 5 is a flow chart illustrating the scanning and printing device of FIG. 1 in the first state. Please refer to FIG. 1 and FIG. 5. In this embodiment, since the sensing module 140 and the printing module 150 are integrated onto the carriage 130, the carriage 130 is driven to pass between the first paper-feeding region F1 and the second paper-feeding region F2 in step S510, and the sensing module 140 can be used in step S520 to scan the image of the first paper 200 in the first paper-feeding region F1, or the printing module 150 can be used in step S530 to print the image to the second paper 300 in the second paper-feeding region F2. In other words, the scanning and printing device 100 in the first state can respectively perform scanning or printing as needed.

FIG. 6 is schematic view illustrating the scanning and printing device of FIG. 1 in the second state. Please refer to FIG. 2 and FIG. 6. The scanning and printing device 100 in the second state, for example, performs printing; that is, the scanning and printing device 100 scans the image of the first paper 200 and prints the image to the second paper 300. In step S610 of this embodiment, the carriage 130 is driven to pass between the first paper-feeding region F1 and the second paper-feeding region F2. In step S620, the sensing module 140 and the printing module 150 have to be driven simultaneously to scan the image on the first paper 200 and print the image to the second paper 300. In order to successfully scan and print the image, step S615 has to be performed before step S620; that is, making the conveying speed V1 of the first paper 200 along the paper-feeding direction A2 be greater than the conveying speed V2 of the second paper 300 along the paper-feeding direction A2. Accordingly, as shown in FIG. 2, the first paper 200 and the second paper 300 can be dislocated against each other along the paper-feeding direction A2, and the distance between the first paper 200 and the second paper 300 is d1. The distance d1 is not limited herein, and the designer may properly adjust the distance according to the circuit layout of the device.

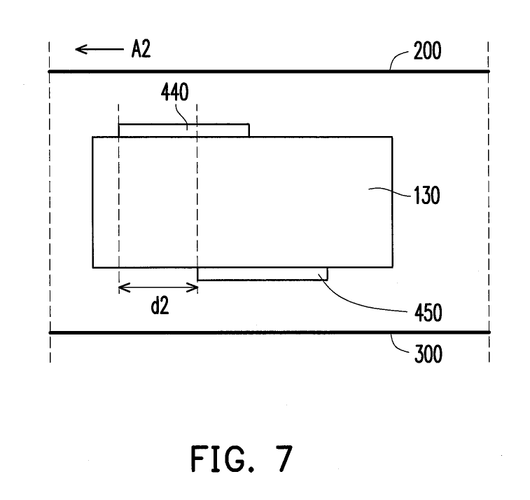

However, the invention should not be construed as limited to the embodiments set forth herein. FIG. 7 is a side view illustrating some components of a scanning and printing device according to another embodiment of the invention. The difference between this embodiment and the embodiments above is that the sensing module 440 and the printing module 450 disposed on the carriage 130 are dislocated against each other in the paper-feeding direction A2, and the distance between the sensing module 440 and the printing module 450 is d2. Thereby, similar effects to those in the abovementioned embodiments may be achieved.

To sum up, in the embodiments of the invention above, a user can selectively scan the first paper on the top surface of the carriage, print images to the second paper beneath the base surface of the carriage, or perform scanning and printing simultaneously because the sensing module and the printing module are disposed on the top surface and the base surface of the carriage at the same time. This enables the scanning and printing device to effectively integrate the printing and scanning modules by the carriage, so as to decrease the space taken inside the body. Besides, due to the synchronization of scanning and printing, working efficiency is improved.

Although the invention has been described with reference to the above embodiments, it will be apparent to persons skilled in the art that modifications to the described embodiments may be made without departing from the spirit of the invention. Accordingly, the scope of the invention will be defined by the attached claims.

What is claimed is:

1. A scanning and printing device comprising:
a carriage sliding back and forth along an axial direction, the carriage having a top surface and a base surface opposite to each other, wherein the top surface faces the first paper, and the base surface faces the second paper;
a sensing module disposed on the top surface of the carriage for scanning an image on the first paper; and
a printing module disposed on the base surface of the carriage for printing the image to the second paper.

2. The scanning and printing device according to claim 1, wherein the first paper and the second paper are dislocated against each other along a paper-feeding direction, so that after the sensing module scans at least part of the image of the first paper, the printing module prints the at least part of the image to the second paper, and the paper-feeding direction is perpendicular to the axial direction.

3. The scanning and printing device according to claim 1, wherein the sensing module and the printing module are dislocated against each other along a paper-feeding direction, so that after the sensing module scans at least part of the image of the first paper, the printing module prints the at least part of the image to the second paper, and the paper-feeding direction is perpendicular to the axial direction.

4. The scanning and printing device according to claim 1, wherein a moving speed of the first paper is greater than a moving speed of the second paper.

5. The scanning and printing device according to claim 1, wherein the sensing module includes a plurality of sensing units arranged on the top surface, the printing module includes a plurality of printing units arranged on the base surface, and an arrangement of the plurality of sensing units is consistent with an arrangement of the plurality of printing units.

6. The scanning and printing device according to claim 5, wherein each of the plurality of sensing units is a contact image sensor (CIS), and each of the plurality of printing units is an ink nozzle.

7. The scanning and printing device according to claim 5, wherein orthographic projection of each of the plurality of sensing units on the base surface are overlapped respectively on the plurality of printing units.

8. The scanning and printing device according to claim 5, wherein the sensing units and the printing units are non-linearly arranged.

9. The scanning and printing device according to claim 1, further comprising:
a body having a first paper-feeding region and a second paper-feeding region, the first paper being suitable to be conveyed in the first paper-feeding region, the second paper being suitable to be conveyed in the second paper-feeding region, and;
an axis shaft disposed extendedly along the axial direction inside the body and located between the first paper-feeding region and the second paper-feeding region, the carriage being slidably coupled to the axis shaft, the printing module being an ink cartridge disposed on the carriage.

10. The scanning and printing device according to claim 1, further comprising:
a control unit electrically connected between the sensing module and the printing module, the control unit having an image buffer region, wherein an image scanned by the sensing module is stored in the image buffer region and later transmitted to the printing module.

11. A method of scanning and printing suitable for a scanning and printing device for scanning a first paper and printing on a second paper, the scanning and printing device comprising a body, a carriage, a sensing module, and a printing module, the body having a first paper-feeding region and a second paper-feeding region, the carriage having a top surface and a base surface opposite to each other, the sensing module being disposed on the top surface, the printing module being disposed on the base surface, the method of scanning and printing comprising:
driving the carriage to pass between the first paper-feeding region and the second paper-feeding region;
scanning an image of the first paper with the sensing module; and
printing the image to the second paper with the printing module.

12. The method of scanning and printing according to claim 11, further comprising:
driving the sensing module and the printing module simultaneously to scan the image of the first paper and print the image to the second paper instantaneously.

13. The method of scanning and printing according to claim 12, further comprising:
dislocating the first paper and the second paper along a paper-feeding direction, so that after the sensing module scans at least part of the image of the first paper, the printing module prints the at least part of the image to the second paper.

14. The method of scanning and printing according to claim 12, wherein a speed of the first paper is greater than a speed of the second paper.
